(19) United States
(12) Patent Application Publication
(10) Pub. No.: US 2007/0290477 A1
(43) Pub. Date: Dec. 20, 2007

(54) Hand propelled personal riding device

(76) Inventor: Che Yin Lee, Hong Kong (CN)

Correspondence Address: Thomas E. Sisson;Jackson Walker, LLP, Suite 2100, 112 E. Pecan, San Antonio, TX, 78205, US

(21) Appl. No.: 11/438,409

(22) Filed: May 22, 2006

(51) Int. Cl. B62M 1/14

(52) U.S. Cl. 280/242.1

(57) ABSTRACT

A hand propelled personal riding device having a riding platform for supporting a rider with a set of driving wheels and a second set of wheels for transporting the platform along a surface, a propulsion handle extending vertically from the platform and moveable in a reciprocating pivotal motion, a gear mechanism provided at the platform and connected to the propulsion handle for converting the reciprocating pivotal motion to a single directional rotary driving motion and a transmission shaft coupled to the gear mechanism for transferring the rotary driving motion of the gear mechanism to the set of driving wheels.

### BACKGROUND TO THE INVENTION

1. Field of the Invention

The present invention relates to a riding device. More particularly, although not exclusively, the invention relates to a hand propelled riding device for personal transportation.

2. Background Information

Personal riding devices such as skateboards are widely available. Skateboards are mainly leg propelled. Propulsion of the skateboard requires extensive movement and can be very energy consuming. The robust nature limits its application and enjoyment to certain age groups. Another problem with conventional skateboards is that it can be difficult for the rider to maintain balance while traveling at high speed. Loss of balance usually result in sever injuries.

### OBJECT OF THE INVENTION

It is the object of the present invention to overcome or substantially ameliorate at least one of the above disadvantages and/or more generally to provide an improved personal riding device, in particular a skateboard, which is easy to manipulate and not as energy consuming as riding of conventional skateboard.

### SUMMARY OF THE INVENTION

There is disclosed herein a hand propelled personal riding device comprising, a riding platform for supporting a rider having a set of driving wheels and a second set of wheels for transporting the platform along a surface substantially parallel to the platform, a propulsion handle extending from the platform and moveable in an angular reciprocating pivotal motion, a gear mechanism provided at the platform and connected to the propulsion handle for converting the reciprocating pivotal motion to a single directional rotary driving motion, and a transmission shaft coupled to the gear mechanism for transferring the rotary driving motion of the gear mechanism to the set of driving wheels.

Preferably, the device comprises of a gear mechanism having a gear housing, a layshaft rotationally mounted with the said housing, a screw gear set comprising a first gear located on the layshaft and a pinion gear, first and second planetary gear set located at either side of the first gear, the first planetary gear set having a stationary first planet gears assembly and a first ring gear fixed to the layshaft, and the second planetary gear set having a second planet gears assembly fixed to the layshaft and a stationary second ring gear, first and second unidirectional couplings connecting the propelling handle to the first ring gear and the second planet gear assembly respectively for transferring the reciprocating pivotal motion to the layshaft.

Further aspects of the invention will become apparent from the following description.

### BRIEF DESCRIPTION OF THE DRAWINGS

An embodiment of the present invention will now be described by way of example only and with reference to the accompanying drawings in which:

FIG. 1 is a perspective view of a hand propelled personal riding device according to the invention,

FIG. 2 is a rear view of the riding device,

FIG. 3 is a top view of the riding device,

FIG. 4 is a bottom view of the riding device,

FIG. 5 is a side view of the riding device,

FIG. 6 is an exploded view of a gear mechanism of the riding device,

FIG. 7 is a sectional view through the gear mechanism,

FIG. 8 is a sectional view a-a of the transmission system of the riding device, and

FIG. 9 is a bottom view of the riding device with a sectional axis a-a

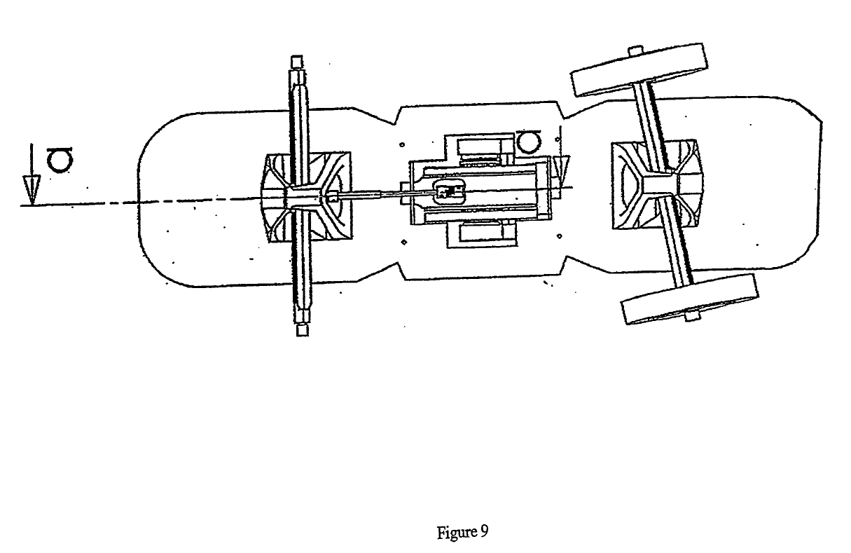

### DESCRIPTION OF THE PREFERRED EMBODIMENT

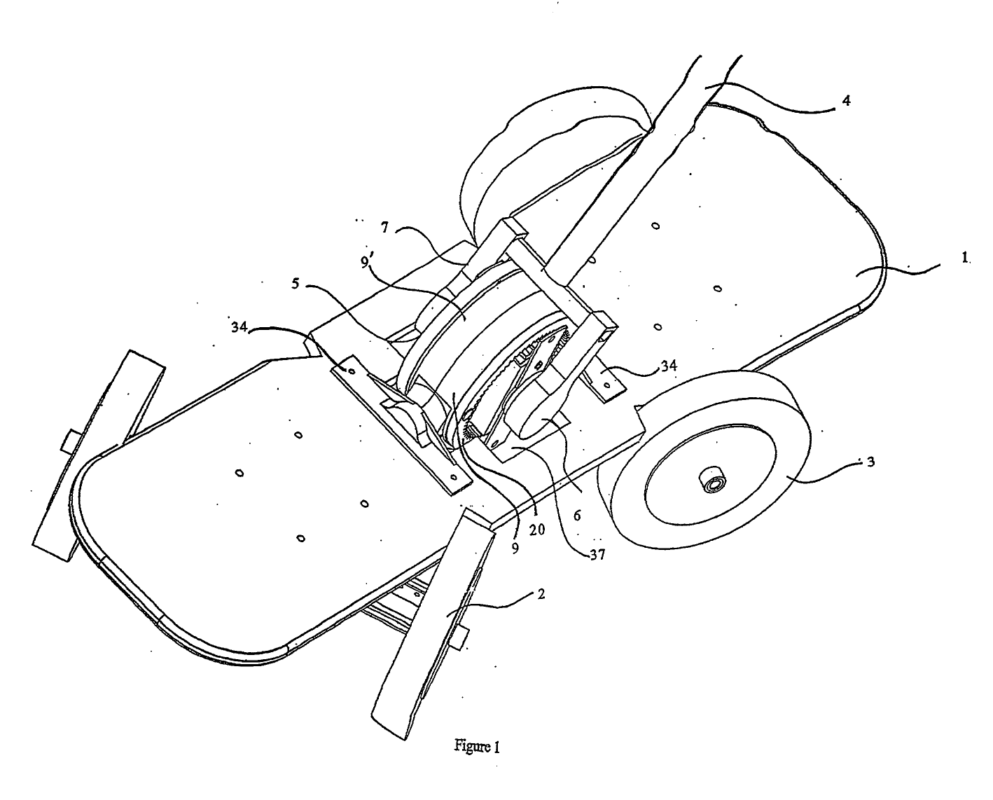

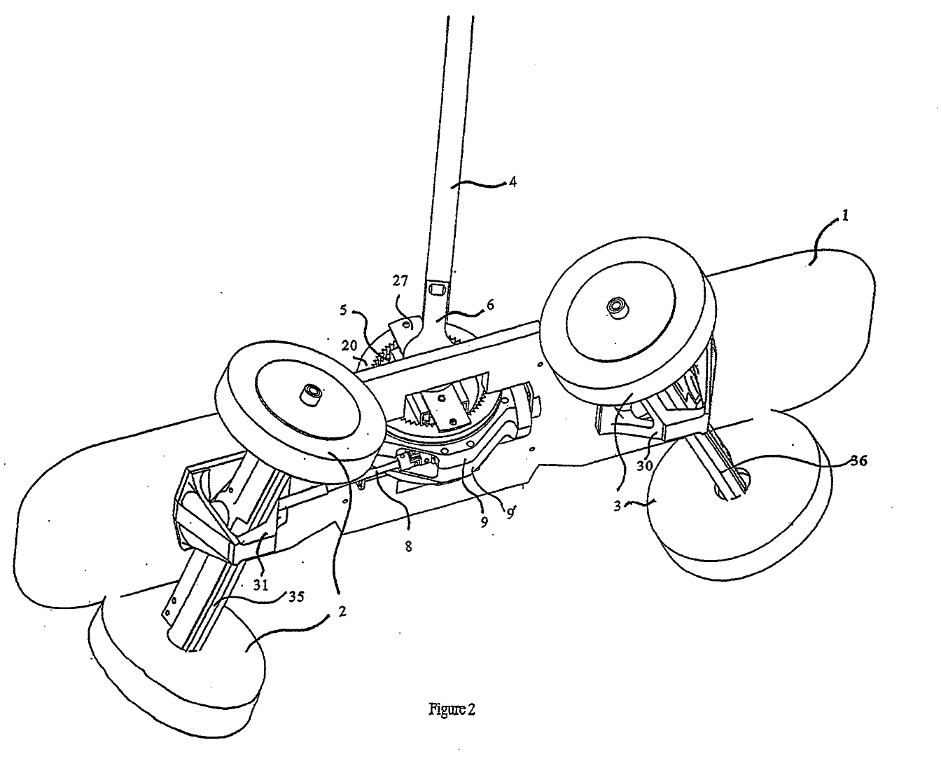

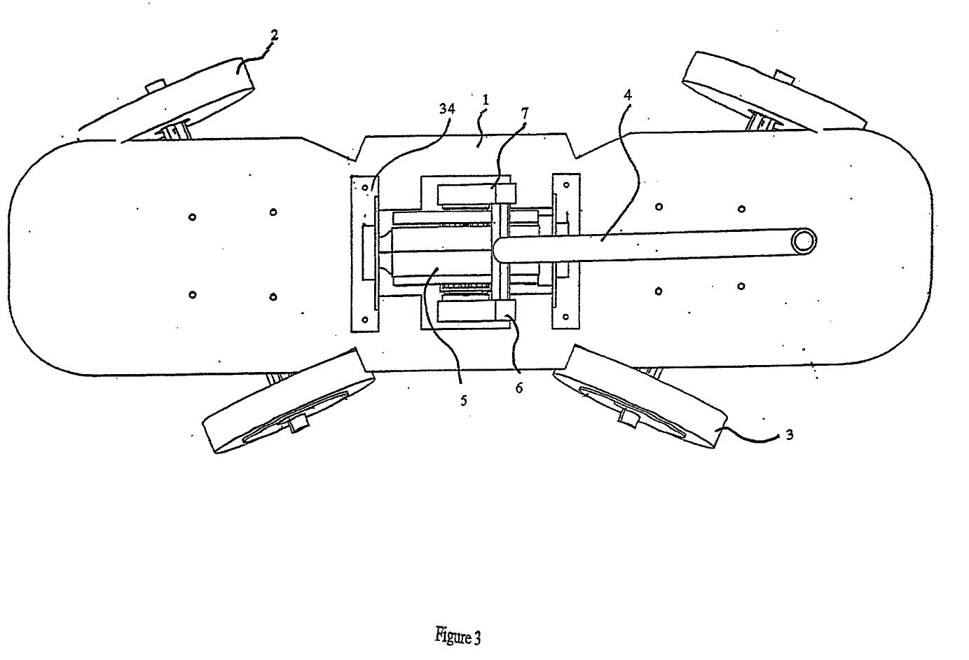

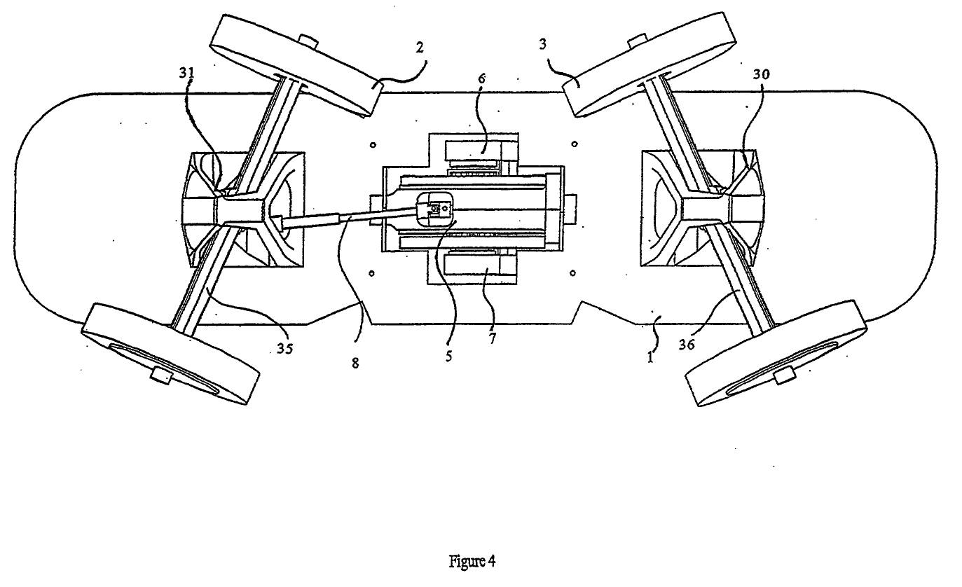

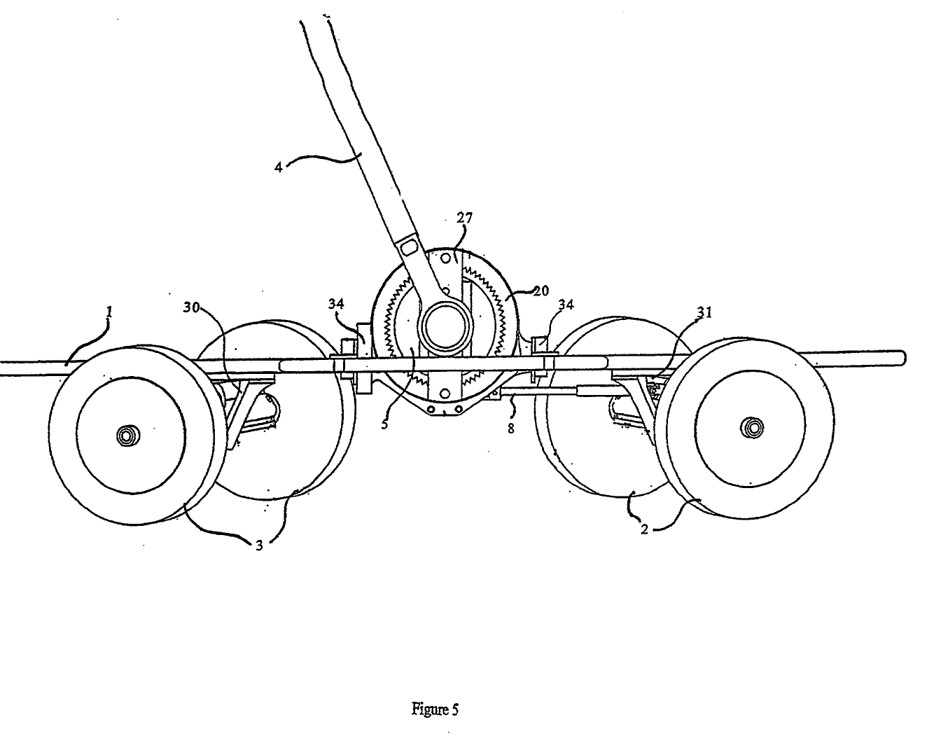

In FIGS. 1 through 5, there is a depiction of the preferred embodiment of a hand propelled personal riding device. The device comprises of a riding platform 1 with a set of driving wheels 2 and a second set of wheels 3 assembled in the form of a skateboard. The wheels 2, 3 are mounted onto either side of the first and second axels 35, 36 extended horizontally from first and second axel housings 31, 30. Typically, the personal riding device has a steering mechanism. The axel housing 30, 31 is mounted to the riding platform in a 10° inclination towards the center of the riding platform 1 to provide a steering effect upon tilting of the riding platform 1. The steering mechanism is well known in skateboard design.

The riding platform 1 has a size to support a single rider in a standing position with an opening 37 in its central section. A gear mechanism 5 is mounted at the opening 37 of the riding platform 1 with a vertically extended pivotal propulsion handle 4. A pair of mounting bracket stands 34 is provided for mounting the gear mechanism 5 to the riding platform 1. The propulsion handle 4 has two actuation arms 6 and 7 to connect with the gear mechanism 5. The propulsion handle 4 is moveable in a reciprocating pivotal motion. In operation, this reciprocal motion is converted to a rotary driving motion by the gear mechanism 5. The rotary driving motion is then transferred to the set of driving wheels 2 by a transmission shaft 8 at the bottom of the riding platform 1. In the preferred embodiment the propulsion handle 4 is extended to a length suitable for hand propulsion of the gear mechanism 5.

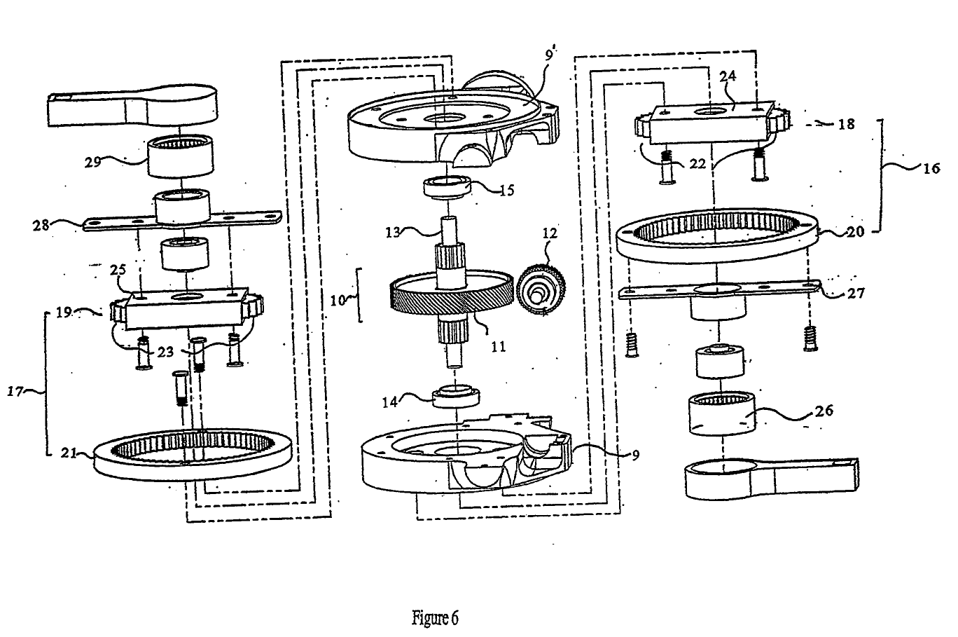

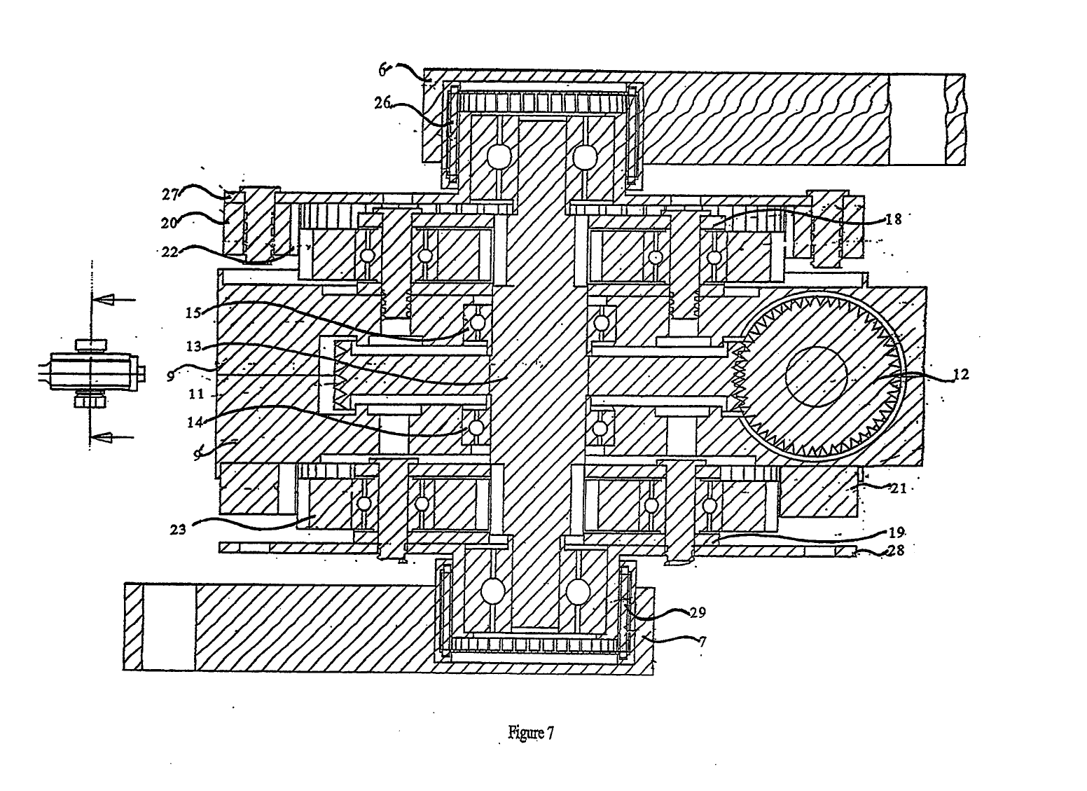

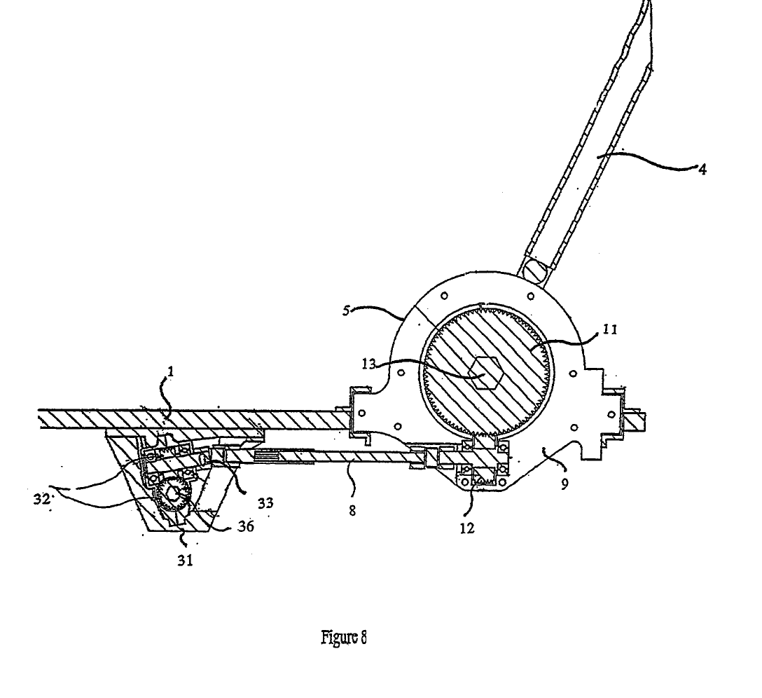

Referring to FIG. 6 to 8, the gear mechanism 5 comprises a gear housing formed from two separable halves 9, 9′ enclosing a screw gear set 10. The screw gear set 10 includes a pinion gear 12 which orthogonally engages with a first gear 11. The first gear 11 is located on a rotational layshaft 13 mounted on bearings 14, 15 to the gear housing 9, 9′. First and second planetary gear set 16, 17 are located at either side of the layshaft 13 outside the housing 9, 9′.

The planetary gear sets 16, 17 include first and second planet gear assemblies 18, 19 and first and second ring gears 20, 21 respectively. Each planet gear assembly 18, 19 further comprises a planet gear carrier 24, 25 and a pair of planet gears 22, 23 respectively.

At the first side of the gear housing 9, the first planetary gear set 16 has its planet gear assembly 18 mounted onto the gear housing 9 and its first ring gear 20 rotationally mounted on the layshaft 13. The first ring gear 20 is supported by a first ring gear stand 27. The propulsion handle 4 is connected to a first unidirectional coupling 26, which transforms the reciprocal motion of the handle 4 to a rotational motion of the ring gear 20 and drives the ring gear to rotate in one direction.

At the second side of the gear housing 9′, the second planetary gear set 17 has its ring gear 21 attached to the side of the gear housing 9′ and its second planet gear assembly 19 rotationally mounted to the layshaft 13. The planet gear assembly 19 is fixed to a second ring gear stand 28. The propulsion handle 4 is connected to a second unidirectional coupling 29 which transforms the reciprocating pivotal motion of the handle 4 to a rotary motion of second planet gear assembly 19 and drives the layshaft 13 to rotate in one direction.

The rotational motion of the layshaft 13 is transferred to the set of driving wheels 2 through the pinion gear 12 along the transmission shaft 8. The transmission shaft 8 is connected with a rear screw gear shaft 33 and a rear screw gear 32 inside the first axel housing 31. In operation the rear screw gear 32 transfers the rotary motion of the rear screw gear shaft 33 to the set of driving wheels 2 through the actuation shaft 36 which is rotationally mounted inside the axel 35.

It should be appreciated that modifications and alterations obvious to those skilled in the art are not to be considered as beyond the scope of the present invention. For example, in the preferred embodiment only one set of wheels is the driving wheels. In an alternative embodiment, the set of front wheels can be assembled to form another set of driving wheels.

The preferred embodiment has the gear mechanism located at the central section of the riding platform. In an alternative embodiment, the gear mechanism located anywhere along the riding platform.

The preferred embodiment has a riding platform supported by two sets of wheels. In an alternative embodiment, the riding platform can be supported by three or more sets of wheels.

What is claimed is:

1. A hand propelled personal riding device comprising:
a riding platform for supporting a rider having a set of driving wheels and a second set of wheels for transporting the platform along a surface substantially parallel to the platform,
a propulsion handle extending from the platform and moveable in a reciprocating pivotal motion,
a gear mechanism provided at the platform and connected to the propulsion handle for converting the reciprocating pivotal motion to a single directional rotary driving motion, and
a transmission shaft coupled to the gear mechanism for transferring the rotary driving motion of the gear mechanism to the set of driving wheels.

2. The hand propelled personal riding device of claim 1 wherein the riding platform has a size to support only a single rider in a standing position.

3. The hand propelled personal riding device of claim 1 wherein the riding platform has an opening for mounting the gear mechanism.

4. The hand propelled riding device of claim 1 wherein the gear mechanism comprises:
a gear housing,
a layshaft rotationally mounted with the said housing,
a screw gear set comprising a first gear located on the layshaft and a pinion gear orthogonally engaging with the first gear
first and second planetary gear sets located at either side of the gear housing,
the first planetary gear set having a stationary first planet gears assembly and a first ring gear fixed to the layshaft, and
the second planetary gear set having a second planet gears assembly fixed to the layshaft and a stationary second ring gear,
first and second unidirectional couplings connecting the propelling handle to the first ring gear and the second planet gear assembly respectively for transferring the reciprocating pivotal motion to the layshaft.

5. The gear mechanism of claim 4 wherein the gear housing comprises a first and second side.

6. The gear mechanism of claim 4 wherein the first planet gears assembly and the second ring gear are attached to the first and the second side of the gear housing respectively.

7. The hand propelled riding device of claim 1 further comprises:
a first axel housing having a rear screw gear shaft, a set of rear screw gears and a first axel for mounting the driving wheels, and
a second axel housing having a second axel for mounting the second set of wheels to support the platform.

8. A hand propelled riding device comprising:
a riding platform having a central section and a set of driving wheels for transporting the platform along a surface,
a propulsion handle extending from the platform and moveable in both rotary directions about the centre line of the layshaft.
a gear mechanism provided at the platform and connected to the propulsion handle for converting the reciprocating pivotal motion of the propulsion handle to a single directional rotary driving motion,
a transmission shaft coupled to the gear mechanism for transferring the single directional rotary driving motion of the gear mechanism to the set of driving wheels, and
a wheel assembly having a first axel housing comprising a wheel shaft, a rear screw gear, an axel and a second axel housing comprising an axel for connecting the wheels to the device.
